(19) United States
(12) Patent Application Publication
(10) Pub. No.: US 2024/0049134 A1
(43) Pub. Date: Feb. 8, 2024

(54) METHOD AND WIRELESS NETWORK FOR MANAGING POWER SAVING FOR EXTENDED REALITY (XR) SERVICE

(71) Applicant: Samsung Electronics Co., Ltd., Suwon-si (KR)

(72) Inventors: Vinay Kumar SHRIVASTAVA, Bangalore (IN); Sriganesh RAJENDRAN, Bangalore (IN); Aby Kanneath ABRAHAM, Bangalore (IN)

(21) Appl. No.: 18/358,767

(22) Filed: Jul. 25, 2023

(30) Foreign Application Priority Data
Jul. 27, 2022 (IN) 202241042925
Jun. 28, 2023 (IN) 202241042925

(51) Int. Cl. H04W 52/02; H04W 72/232; H04W 76/28; H04W 72/12

(52) U.S. Cl. CPC H04W 52/0225; H04W 72/232; H04W 76/28; H04W 72/12

(57) ABSTRACT

The disclosure relates to a 5G or 6G communication system for supporting a higher data transmission rate. Embodiments herein disclose methods for managing power saving for an XR service in a wireless network by a UE. The method includes receiving a radio bearer configuration comprising an identifier field. Further, the method includes determining whether the received radio bearer configuration includes an “isXR bearer” field as the identifier field.

### CROSS-REFERENCE TO RELATED APPLICATIONS

This application is based on and claims priority under 35 U.S.C. § 119 to Indian Provisional Patent Application No. 202241042925, filed on Jul. 27, 2022, and Indian Non-Provisional Patent Application No. 202241042925, filed on Jun. 28, 2023, in the Indian Patent Office, the disclosure of which is incorporated by reference herein in its entirety.

### BACKGROUND

### 1. Field

Embodiments disclosed herein relate to wireless networks, and more particularly to methods and the wireless networks for managing an extended reality (XR) service.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

The principal object of the embodiments herein is to disclose methods and systems (or wireless networks) for managing power saving for an XR service reception in wireless communication, wherein a DRX mechanism (comprising of operation of DRX timers for XR service reception) has been disclosed for power saving.

Another object of the embodiments herein is to disclose about a DRX mechanism for the XR in a wireless network.

Another object of the embodiments herein is to disclose multiple pre-defined configurations of the DRX for XR and switching across them.

Another object of the embodiments herein is to disclose about an identification of an XR bearer field in radio bearer configuration signalling.

Another object of the embodiments herein is to disclose about a UE capability for the support for multiple DRX configurations and XR power saving.

Another object of the embodiments herein is to disclose about a configurable or a dynamic offset for the DRX pre-ponement/advancement.

### SUMMARY

Accordingly, the embodiments herein provide methods for managing power saving for an XR service in a wireless network. The method includes receiving, by a user equipment (UE), a radio bearer configuration comprising an identifier field. Further, the method includes determining, by the UE, whether the received radio bearer configuration includes an “isXR bearer” field as the identifier field. Further, the method includes performing, by the UE, one of: identifying the radio bearer pertaining to the XR service upon determining that the radio bearer configuration includes the “isXR bearer” field, and identifying the radio bearer not pertaining to the XR service upon determining that the radio bearer configuration does not include the “isXR bearer” field.

In an embodiment, the method includes receiving, by the UE, a configurable value or a dynamic value for at least one of a drx-StartOffsetXR and a drx-slotOffsetXR in at least one of a downlink control information (DCI), a wake-up signal (WUS), a downlink control indication (DCI) with cyclic redundancy code (CRC) scrambled by power saving-radio network temporary identifier (PS-RNTI) (DCP), a wake-up radio (WUR), a medium access control control element (MAC CE) and radio resource control (RRC) signalling from a network apparatus for the at least one XR service (or bearer or logical channel). Further, the method includes applying, by the UE, at least one of the drx-StartOffsetXR and the drx-slotOffsetXR as a pre-ponement or a deferment for starting of a drx-onDurationTimer for a XR service reception. Further, the method includes applying, by the UE, at least one of the drx-StartOffsetXR and the drx-slotOffsetXR to computation of at least one of a short discontinuous reception (DRX) and a long DRX for the XR service reception.

In an embodiment, at least one of the XR service reception and a XR service transmission is performed with re-utilizing at least one of a cell radio network temporary identifier (C-RNTI) and a configured scheduling radio network temporary identifier (CS-RNTI) of a unicast reception and a unicast transmission.

In an embodiment, the XR service uses at least one of a C-RNTI and a CS-RNTI if the XR service is multiplexed on a same medium access control protocol data unit (MAC PDU) with at least one of a non-XR service and a legacy unicast.

In an embodiment, the method includes receiving, by the UE, a radio resource control (RRC) re-configuration message including a set of configured values for at least one of a drx-StartOffsetXR and a drx-slotOffsetXR. Further, the method includes applying, by the UE, at least one value from the set of configured values to change a starting of a drx-onDurationTimer based on indication from at least one of a DCI, a WUS, a DCP, a WUR and a MAC CE scrambled using at least one of an XR-RNTI, a XR-CS-RNTI, a C-RNTI and a CS-RNTI for reception of the XR service, wherein at least one value from the set of configured values is indicated by an index to the set of configured values or a bitmap or a field representing the configured value to be applied.

In an embodiment, the method includes configuring the UE with at least one DRX configuration parameter from multiple DRX configurations. The at least one DRX configuration parameter includes at least one of a drx-OnDurationTimer, a drx-inactivityTimer, a Round-Trip-Time (RTT) timer, and a retransmission timer. The network apparatus configures the UE with at least one DRX configuration parameter from the multiple DRX configurations. Further, the method includes associating a DRX configuration from the multiple DRX configurations with a XR session for the XR service based on the at least one DRX configuration parameter.

In an embodiment, the method includes determining, by the UE, whether there is at least one DRX configuration for the XR service during a DRX Active Time. Further, the method includes monitoring, by the UE, a Physical Downlink Control Channel (PDCCH) search space for the XR service during the DRX Active Time.

In an embodiment, the method includes indicating a capability to support multiple DRX configurations through at least one of a UE capability information exchange procedure and a UE assistance information.

In an embodiment, the method includes indicating whether the UE supports a power saving preference for the XR in a UE capability message.

In an embodiment, the method includes indicating a maximum number of DRX configurations that the UE supports.

In an embodiment, the method includes indicating a preference of at least one of a common DRX configuration for a legacy unicast and the XR service, a separate DRX configurations for the legacy unicast and the XR service, a common DRX configuration or a per service DRX configuration, a preferred RTT timer value and a preferred retransmission timer value for XR services in a UE assistance information.

In an embodiment, the method includes identifying, by the UE, whether at least two DRX configurations are applied for one or more XR service reception. Further, the method includes switching, by the UE, among the at least two DRX configurations from the multiple DRX configurations. Further, the method includes receiving, by the UE, an indication of a suitable DRX configuration among the at least two DRX configurations for the XR reception using at least one of a DCI, a WUS, a WUR and a MAC CE.

In an embodiment, the indicated DRX configuration is applicable for a predefined time.

In an embodiment, the method includes receiving, by the UE, a MAC CellGroupConfig message. The MAC CellGroupConfig message configures a medium access control (MAC) parameter for a cell group including at least one of a setup of drx-Config, a setup of drx-ConfigSecondaryGroup, a release of drx-Config and a release of drx-ConfigSecondaryGroup for at least one of a legacy unicast and a XR service reception.

In an embodiment, the DRX configuration differ in at least one parameter including at least one of a drx-onDurationTimer, a drx-inactivityTimer, a drx-HARQ-RTT-TimerUL, a drx-HARQ-RTT-TimerDL, a drx-RetransmissionTimerUL, a drx-RetransmissionTimerDL, a drx-SlotOffsetXR, a drx-SlotOffsetXR-static, a drx-Shortcycle, a drx-ShortcycleTimer, a drx-LongCycle, a drx-StartOffsetXR and a drx-StartOffsetXR-static.

In an embodiment, a HARQ process utilized for the XR service is common and shared with a legacy unicast or a non-XR service.

Accordingly, the embodiments herein provide methods for managing power saving for an XR service in a wireless network. The method includes sending, by a network apparatus, a radio bearer configuration including an identifier field as “isXR bearer” field to identify a radio bearer pertaining to the XR service to the UE in the wireless network. Further, the method includes managing, by the network apparatus, the XR service in the wireless network based on the radio bearer configuration including the “isXR bearer” field.

In an embodiment, the method includes sending a configurable value or a dynamic value for at least one of a drx-StartOffsetXR and a drx-slotOffsetXR in at least one of a DCI, a WUS, a DCP, a WUR, a MAC CE and a RRC signalling to the UE for the XR service.

In an embodiment, the method includes sending a RRC re-configuration message including a set of configured values for at least one of a drx-StartOffsetXR and a drx-slotOffsetXR to the UE for the XR service.

In an embodiment, the method includes configuring the UE with at least one DRX configuration parameter from the multiple DRX configurations.

Accordingly, the embodiments herein provide a UE including a XR service controller coupled with a processor and a memory. The XR service controller is configured to receive a radio bearer configuration comprising an identifier field. Further, the XR service controller is configured to determine whether the received radio bearer configuration including an “isXR bearer” field as an identifier field. Further, the XR service controller is configured to perform one of: identify the radio bearer pertaining to the XR service upon determining that the radio bearer configuration includes the “isXR bearer” field, and identify the radio bearer not pertaining to the XR service upon determining that the radio bearer configuration does not include the “isXR bearer” field.

Accordingly, the embodiments herein provide a network apparatus including a XR service controller coupled with a processor and a memory. The XR service controller is configured to send a radio bearer configuration including an identifier field as “isXR bearer” field to identify a radio bearer pertaining to the XR service to the UE in the wireless network. Further, the XR service controller is configured to manage the XR service in the wireless network based on the radio bearer configuration including the “isXR bearer” field.

Accordingly, the embodiments herein provide a method performed by a user equipment (UE) in a communication system. The method includes: receiving a radio bearer configuration associated with a radio bearer; determining whether the radio bearer configuration includes an identifier field associated with extended reality (XR); and identifying the radio bearer being associated with an XR service based on determining that the radio bearer configuration includes the identifier field.

In an embodiment, the method includes performing an XR service communication associated with the XR service based on the identification.

In an embodiment, the XR service communication is scheduled based on a physical downlink control channel (PDCCH) addressed to one of a first radio network temporary identifier (RNTI) or a second RNTI.

In an embodiment, wherein the first RNTI is one of a cell-RNTI (C-RNTI) or a configured scheduling-RNTI (CS-RNTI).

In an embodiment, the second RNTI is one of an XR-RNTI or an XR-CS-RNTI.

In an embodiment, in case that the PDCCH is addressed to the first RNTI, the XR service communication is multiplexed with communication associated with non-XR service.

In an embodiment, a hybrid automatic repeat and request (HARQ) process utilized for the XR service is a shared process with a HARQ process utilized for non-XR service.

In an embodiment, the method includes receiving configuration information associated with multiple discontinuous reception (DRX) configurations; and monitoring a PDCCH search space for the XR service based on a first DRX configuration among the multiple DRX configurations.

In an embodiment, the multiple DRX configurations differ from each other in at least one DRX parameter including at least one of a drx-onDurationTimer, a drx-inactivityTimer, a drx-HARQ-RTT-TimerUL, a drx-HARQ-RTT-TimerDL, a drx-RetransmissionTimerUL, a drx-RetransmissionTimerDL, a drx-SlotOffsetXR, a drx-SlotOffsetXR-static, a drx-Shortcycle, a drx-ShortcycleTimer, a drx-LongCycle, a drx-StartOffsetXR, or a drx-StartOffsetXR-static.

In an embodiment, the method includes switching to a second DRX configuration among the multiple DRX configurations, wherein the second DRX configuration is different from the first DRX configuration; and monitoring a PDCCH search space for the XR service based on the second DRX configuration.

Accordingly, the embodiments herein provide a UE including a transceiver; and a processor coupled with the transceiver. In an embodiment, the processor is configured to: receive a radio bearer configuration associated with a radio bearer; determine whether the radio bearer configuration includes an identifier field associated with extended reality (XR); and identify the radio bearer being associated with an XR service based on determining that the radio bearer configuration includes the identifier field.

Accordingly, the embodiments herein provide a method performed by a network apparatus in a communication system. The method includes: identifying whether a radio bearer is associated with an extended reality (XR) service; transmitting a radio bearer configuration associated with the radio bearer, wherein the radio bearer configuration includes an identifier field associated with XR based on identifying that the radio bearer is associated with the XR service; and performing communication associated with the XR service.

Accordingly, the embodiments herein provide a network apparatus including a transceiver and a processor coupled with the transceiver. In an embodiment, the processor is configured to: identify whether a radio bearer is associated with an extended reality (XR) service; transmit a radio bearer configuration associated with the radio bearer, wherein the radio bearer configuration includes an identifier field associated with XR based on identifying that the radio bearer is associated with the XR service; and perform communication associated with the XR service.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 illustrates a wireless network for managing power saving for an XR service according to the embodiments as disclosed herein;

FIG. 2 illustrates various hardware components of a UE according to the embodiments as disclosed herein;

FIG. 3 illustrates various hardware components of a network apparatus, according to the embodiments as disclosed herein;

FIG. 4 illustrates a flowchart of method, implemented by the UE, for managing power saving for the XR service in the wireless network according to the embodiments as disclosed herein;

FIG. 5 illustrates a flowchart of method for managing power saving for the XR service in the wireless network according to embodiments as disclosed herein;

FIG. 6 illustrates a flowchart of a configurable or a dynamic offset operation to a common DRX for the XR and a legacy unicast/non-XR reception according to embodiments as disclosed herein;

FIG. 7 illustrates a flowchart of an operational flow for active time determination for a common DRX for the XR and the legacy unicast/non-XR reception according to embodiments as disclosed herein;

FIG. 8 illustrates a flowchart of an operational flow for DRX timers operation for the common DRX for the XR and the legacy unicast/non-XR reception when a MAC PDU is received in a configured downlink assignment according to embodiments as disclosed herein;

FIG. 9 illustrates a flowchart of an operational flow for the DRX timers operation for the common DRX for the XR and legacy unicast/non-XR reception when a PDCCH indicates a DL transmission according to embodiments as disclosed herein;

FIG. 10 illustrates flowchart of a dynamic offset operation to a DRX for XR service reception according to embodiments as disclosed herein;

FIG. 11 illustrates a flowchart of an operational flow for Active time determination for the XR service reception according to embodiments as disclosed herein;

FIG. 12 illustrates a flowchart of an operational flow for DRX timers operation for a DRX for XR service reception when a MAC PDU is received in a configured downlink assignment according to embodiments as disclosed herein; and

FIG. 13 illustrates a flowchart of an operational flow for DRX timers operation for a DRX for the XR service reception when the PDCCH indicates the DL transmission according to embodiments as disclosed herein.

FIG. 14 illustrates an electronic device according to embodiments of the present disclosure.

FIG. 15 illustrates a network apparatus according to embodiments of the present disclosure.

### DETAILED DESCRIPTION

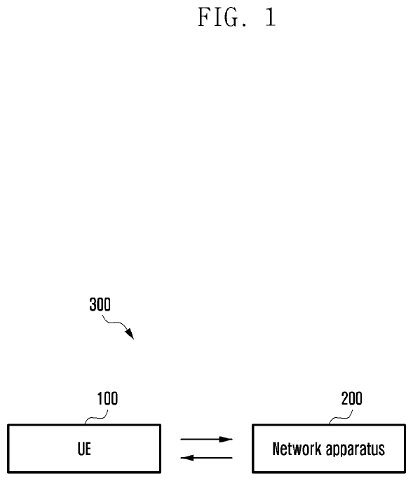

FIGS. 1 through 15, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

Extended reality (XR) is an umbrella term for different realities including virtual reality (VR), augmented reality (AR) and mixed reality (MR), and is considered as an essential technology to enable the realization of digital twin/meta universe. The XR is incorporated as an agreed work item in fifth generation (5G) Advanced (i.e., 3rd generation partnership project (3GPP) Release 18), which is targeted to provide a communication system framework that fulfills challenging needs of high data rate, very low latency, and power efficient connectivity for XR applications. Particularly for power saving for the XR, a discontinuous reception (DRX) mechanism may be required.

It is desired to address the short comings or at least provide a useful alternative.

Without the loss of generality or specificity, the provided embodiments can be interchangeably interpreted and applied to at least one XR service, bearer, logical channel, transport channel, physical channel or QoS flow and so on.

The embodiments herein achieve methods for managing power saving for an XR service in a wireless network. The method includes receiving, by a UE, a radio bearer configuration comprising an identifier field. The method includes determining, by the UE, whether the received radio bearer configuration includes an “isXR bearer” field as the identifier field. Further, the method includes performing, by the UE, one of: identifying the radio bearer pertaining to the XR service upon determining that the radio bearer configuration includes the “isXR bearer” field, and identifying the radio bearer not pertaining to the XR service upon determining that the radio bearer configuration does not include the “isXR bearer” field.

The methods can be used for managing power saving for the XR in wireless communication, wherein a DRX mechanism (comprising of operation of DRX timers for XR service reception) has been disclosed for power saving. Based on the provided method, the enhanced DRX mechanism ensures power saving as well as low latency for the XR packets transfer. Thus, results in enhancing the user experience and UE/network performance.

Referring now to the drawings, and more particularly to FIGS. 1 through 13, where similar reference characters denote corresponding features consistently throughout the figures, there are shown at least one embodiment.

FIG. 1 illustrates a wireless network (300) for managing an XR service according to the embodiments as disclosed herein. The wireless network (300) can be, for example, but not limited to a fourth generation (4G) network, a fifth generation (5G) network, a sixth generation (6G) network, an open radio access network (ORAN) or the like. In an embodiment, the wireless network (300) includes a UE (100) and a network apparatus (200). The UE (100) can be, for example, but not limited to a laptop, a smart phone, a desktop computer, a notebook, a device-to-device (D2D) device, a vehicle to everything (V2X) device, a foldable phone, a smart TV, a tablet, an immersive device, and an internet of things (IoT) device. The network apparatus (200) can be, for example, but not limited to a gNB, a eNB, a new radio (NR) trans-receiver or the like.

The UE (100) receives a radio bearer configuration comprising an identifier field. Further, the UE (100) determines whether the received radio bearer configuration includes an “isXR bearer” field as the identifier field. In an embodiment, upon determining that the radio bearer configuration includes the “isXR bearer” field, the UE (100) identifies the radio bearer pertaining to the XR service. In another embodiment, upon determining that the radio bearer configuration does not includes the “isXR bearer” field, the UE (100) identifies the radio bearer not pertaining to the XR service.

In an embodiment, one or more dedicated RNTI(s) are utilized to receive or transmit a plurality of XR data or control channels. The assignment of the RNTI(s) can be per XR bearer, XR service, per XR flow/sub-flow or per XR logical channel. In an embodiment, the RNTI(s) may also be assigned for a group of one of XR bearers, or services, or flows, or sub-flows, or logical channels. The RNTI(s) can also be one or more of XR-RNTI(s) and XR-CS-RNTI(s) to address dynamically and/or semi-persistent and/or configured grant/assignment based scheduling of the XR.

In an embodiment, each of the XR-RNTI(s) and XR-CS-RNTI(s) based scheduling for the XR services/bearers can be based on a dedicated DRX configuration. In an embodiment, one or more of the XR-RNTI(s) and/or XR-CS-RNTI(s) based scheduling for XR services/bearers may also share the same DRX configurations i.e., a grouping of DRX configurations is configured and utilized.

In an embodiment, the one or more XR service reception and/or transmission can be performed with re-utilizing the C-RNTI and/or CS-RNTI of the unicast reception and/or transmission.

In an embodiment, each of the XR-RNTI(s) and XR-CS-RNTI(s) based scheduling for XR services/bearers share the same DRX configuration with the legacy unicast (or non-XR) reception.

In an embodiment, if a XR DRX is configured for a MAC entity of the UE (100) in a RRC_CONNECTED state, the MAC entity monitors a PDCCH discontinuously for a XR reception (i.e., addressed to XR-RNTI and/or XR-CS-RNTI) using the DRX operation only for the relevant activated serving cells for which XR service(s) is/are configured. The relevant activated serving cells for the XR-RNTI or XR-CS-RNTI monitoring are as per the XR radio bearer configuration in a RRC reconfiguration message from the network apparatus (200) providing “served cell(s)” where pertinent XR service is to be provided. In an embodiment, the MAC entity monitors the PDCCH discontinuously for all activated serving cells for the XR reception using the DRX operation.

In an embodiment, separate PDCCH search spaces may be configured for the legacy unicast (or non-XR) services and the XR services. In an embodiment, more than one XR service may share the PDCCH search space.

In an embodiment, the MAC entity of the UE (100) may share the DRX on-duration timer (i.e., drx-onDurationTimer) and/or the DRX inactivity timer (i.e., drx-InactivityTimer) of the XR configuration of one or more XR services with the unicast (non-XR or legacy unicast) DRX configuration, however, based on latency requirement, the MAC entity may have separate XR configuration of one or more XR services for Round-Trip-Time (RTT) timer (i.e., drx-HARQ-RTT-TimerDL-XR and/or drx-HARQ-RTT-TimerUL-XR) and/or Retransmission timer (i.e., drx-RetransmissionTimerDL-XR and/or drx-RetransmissionTimerUL-XR) in at least one of downlink direction and uplink direction than the unicast (non-XR or legacy unicast) DRX configuration.

In an embodiment, the radio bearer configuration includes a field “isXR bearer” to distinguish or identify if the radio bearer pertains to XR or not. In an embodiment, at least one dedicated logical channel with at least one logical channel identity (e.g., LC ID) or a range of LCID (e.g., XR control channel, XRCCH and/or XR traffic channel, XRTCH) are utilized to distinguish the reception and/or transmission including multiplexing and/or de-multiplexing of XR control/traffic contents from non-XR or legacy unicast control/traffic contents. In this case, the XR service may also use same C-RNTI/CS-RNTI if they are multiplexed on to same MAC PDU with a non-XR service and/or legacy unicast. Further, embodiments herein assume XR-RNTI/XR-CS-RNTI for the XR; however, it may be obvious to a person of ordinary skill in the art that the C-RNTI/CS-RNTI may also be utilized for the described behavior without the loss of generality.

In an embodiment, an example specification text is provided illustrating the operational details for XR DRX in conjunction with the unicast (or non-XR) DRX configuration.

Discontinuous reception (DRX): The MAC entity may be configured by the RRC with the DRX functionality that controls the UE's PDCCH monitoring activity for the MAC entity's C-RNTI, the CI-RNTI, the CS-RNTI, an INT-RNTI, a SFI-RNTI, a SP-CSI-RNTI, a TPC-PUCCH-RNTI, a TPC-PUSCH-RNTI, a TPC-SRS-RNTI, an AI-RNTI, a SL-RNTI, a SLCS-RNTI, a SL Semi-Persistent Scheduling V-RNTI, an XR-RNTI and an XR-CS-RNTI. When using the DRX operation, the MAC entity may also monitor PDCCH according to requirements (as disclosed herein). When in the RRC_CONNECTED, if the DRX is configured, for all the activated Serving Cells, the MAC entity may monitor the PDCCH discontinuously using the DRX operation specified in this clause; else, the MAC entity may monitor the PDCCH as specified in TS 38.213. When in the RRC_CONNECTED, if the XR DRX is configured, for the “relevant” activated serving cells, the MAC entity may monitor the PDCCH discontinuously using the DRX operation specified in this clause. Else, the MAC entity may monitor the PDCCH as specified in TS 38.213.

The RRC can control the DRX operation by configuring the following parameters:
a) drx-onDurationTimer: the duration at the beginning of a DRX cycle;
b) drx-SlotOffset: the delay before starting the drx-onDurationTimer;
c) drx-InactivityTimer: the duration after the PDCCH occasion in which a PDCCH indicates a new uplink (UL) or downlink (DL) transmission for the MAC entity;
d) drx-RetransmissionTimerDL (per DL HARQ process except for the broadcast process): the maximum duration until a DL retransmission is received;
e) drx-RetransmissionTimer UL (per UL HARQ process): the maximum duration until a grant for UL retransmission is received;
f) drx-LongCycleStartOffset: the Long DRX cycle and drx-StartOffset which defines the subframe where the Long and Short DRX cycle starts;
g) drx-ShortCycle (optional): the Short DRX cycle;
h) drx-ShortCycle Timer (optional): the duration the UE (100) may follow the Short DRX cycle;
i) drx-HARQ-RTT-TimerDL (per DL HARQ process except for the broadcast process): the minimum duration before a DL assignment for HARQ retransmission is expected by the MAC entity;
j) drx-HARQ-RTT-TimerUL (per UL HARQ process): the minimum duration before a UL HARQ retransmission grant is expected by the MAC entity;
k) ps-Wakeup (optional): the configuration to start associated drx-onDurationTimer in case DCP is monitored but not detected;
l) drx-RetransmissionTimerDL-XR (per DL HARQ process for the XR): the maximum duration until a DL XR retransmission is received;
m) drx-HARQ-RTT-TimerDL-XR (per DL HARQ process for XR): the minimum duration before a DL XR assignment for the HARQ retransmission is expected by the MAC entity; n) drx-RetransmissionTimer UL-XR (per UL HARQ process): the maximum duration until a grant for UL retransmission is received; and
o) drx-HARQ-RTT-TimerUL-XR (per UL HARQ process): the minimum duration before a UL HARQ retransmission grant is expected by the MAC entity.

In an embodiment, a dynamic parameter (drx-StartOffsetXR-dyna) can be signaled to the UE (100) by the network apparatus (200) which provides for the at least one of the preponement or the deferment for starting the drx-onDurationTimer by a signaled offset value in order to receive XR. This alteration of the DRX start time is needed due to XR frame rate mismatch and/or variation with the configured DRX and/or jitter of the arrival of the XR data. In an embodiment, the drx-StartOffsetXR-dyna may also be composed of two parts or parameters e.g., drx-StartOffsetXR and/or drx-slotOffsetXR in order to have both sub-frame offset and slot level offset respectively. The parameter drx-StartOffsetXR and/or drx-slotOffsetXR may be signaled to the UE (100) dynamically by the network apparatus (200) by utilizing at least one of downlink control information (DCI, e.g., a scheduling DCI), a presence or absence or location and/or embedded information (e.g., PDCCH/DCI based signaling) of the wakeup signal (WUS), a presence or absence and/or location of the wakeup radio (WUR) sequence/pattern or a MAC control element (CE).

The parameter drx-StartOffsetXR and/or drx-slotOffsetXR may be associated to the one or more specific XR service(s) or may be applicable collectively for all the configured XR service(s). The identification of the drx-StartOffsetXR and/or the drx-slotOffsetXR parameter for the specific XR service is through at least one of associated DCI, the WUS, the WUR or the MAC CE addressed to (or scrambled by) the XR-RNTI or the XR-CS-RNTI or the C-RNTI, or associated DCI, the WUS, the WUR or the MAC CE carrying XR service field information. The drx-StartOffsetXR and/or the drx-slotOffsetXR may be applicable or valid for one or more DRX cycles and the validity duration may also be indicated or configured to the UE (100).

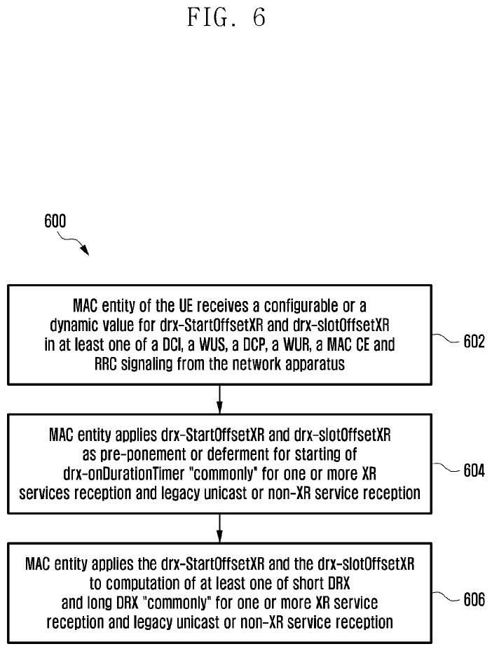

Further, the drx-StartOffsetXR and/or the drx-slotOffsetXR may be defined and configured separately for short DRX cycle as the drx-StartOffsetXR-shortDRX and/or the drx-slotOffsetXR-shortDRX” and/or the long DRX cycle as “drx-StartOffsetXR-longDRX and/or drx-slotOffsetXR-LongDRX” or as the common parameter “drx-StartOffsetXR and/or drx-slotOffsetXR” for the short DRX cycle and/or long DRX cycle. In an alternate embodiment, a set of values for the drx-StartOffsetXR and/or drx-slotOffsetXR for one or more XR services is configured by the network apparatus (200) through the RRC (re-)configurations and the UE (100) applies the configured value to advance or delay the starting of drx-onDurationTimer based on reception of DCI, WUS, WUR or MAC CE scrambled using an XR-RNTI or an XR-CS-RNTI or an C-RNTI. In an example, receiving an index to the set of values configured or a bitmap or a field representing the configured value is to be applied. This is illustrated in FIG. 6.

In an example, below are the dynamic parameters:
a) drx-StartOffsetXR: the preponement or the deferment for starting the drx-onDurationTimer in number of subframes or milliseconds; and
b) drx-slotOffsetXR: the preponement or the deferment for starting the drx-onDurationTimer in number of slots or sub-milliseconds.

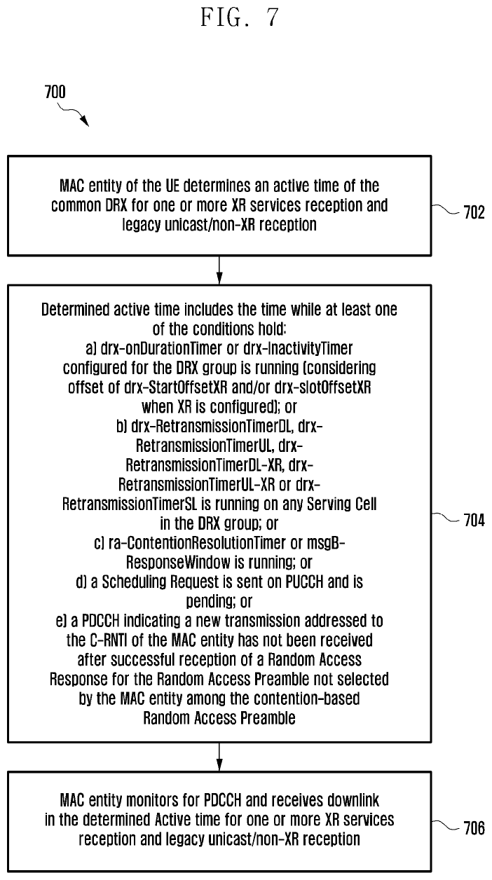

In an embodiment, the MAC entity determines the Active Time of the DRX when one or more XR services are configured and/or being accessed by the UE (100), as depicted in FIG. 7 and illustrated by an example specification as follows:

In an example, when the DRX is configured, the active time for Serving Cells in a DRX group includes the time while:
a. drx-onDurationTimer or drx-InactivityTimer configured for the DRX group is running (considering offset of drx-StartOffsetXR and/or drx-slotOffsetXR when XR is configured); or
b. drx-RetransmissionTimerDL, drx-RetransmissionTimerUL, drx-RetransmissionTimerDL-XR, drx-RetransmissionTimerUL-XR or drx-RetransmissionTimerSL is running on any serving cell in the DRX group; or
c. ra-ContentionResolutionTimer or msgB-ResponseWindow is running; or
d. a scheduling request is sent on PUCCH and is pending. If this serving cell is part of a non-terrestrial network, the Active Time is started after the scheduling request transmission that is performed when the SR COUNTER is 0 for all the SR configurations with pending SR(s) plus the UE-gNB RTT; or
e. a PDCCH indicating a new transmission addressed to the C-RNTI of the MAC entity has not been received after successful reception of a random access response for the random access preamble not selected by the MAC entity among the contention-based random access preamble.

In an embodiment, the HARQ process or processes that is at least one of configured or assigned for XR is/are separate from the HARQ process or processes that is at least one of configured or assigned for legacy unicast (or non-XR) reception. The configuration or assignment can be based on at least one of applicable time slot as per configuration, indicated RNTI, HARQ process identity and so on. The MAC entity determines the HARQ process for the received MAC PDU in a configured downlink assignment for unicast is configured or assigned for XR or legacy unicast (or non-XR), and accordingly, operate the relevant RTT timer for downlink and/or Retransmission timer for downlink. Further, when the MAC entity determines the HARQ process for the received MAC PDU in the configured downlink assignment for the unicast is configured or assigned for the XR, the MAC entity does not stop drx-RetransmissionTimerDL-PTM for MBS Point-To-Multipoint multicast.

In an embodiment, the HARQ process or processes utilized for XR services are common and shared with the legacy unicast or the non-XR services. That is, multiplexing (or de-multiplexing) of XR and non-XR traffic is allowed over the MAC transport block and C-RNTI/CS-RNTI is used to address the MAC TB. De-multiplexing (or multiplexing) of XR and non-XR MAC SDUs is performed by MAC Demux (or Mux) entity utilizing the MAC header information; e.g., LCID fields.

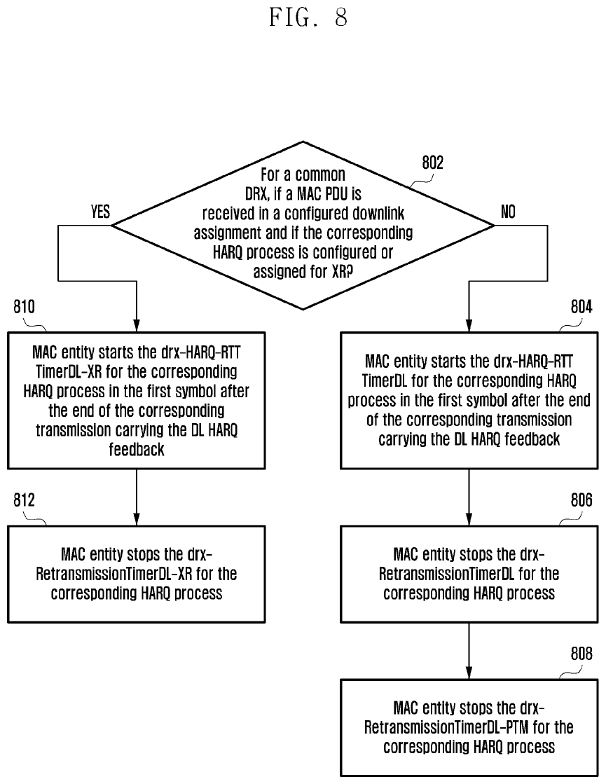

In an embodiment, the DRX procedure is depicted in FIG. 8 and illustrated by an example specification as follows:

In an example, when the DRX is configured, the MAC entity may:
1> if a MAC PDU is received in a configured downlink assignment for unicast:
   2> if the corresponding HARQ process is configured or assigned for XR:
      3> start the drx-HARQ-RTT-TimerDL-XR for the corresponding HARQ process in the first symbol after the end of the corresponding transmission carrying the DL HARQ feedback;
      3> stop the drx-RetransmissionTimerDL-XR for the corresponding HARQ process.
   2> else:
      3> start the drx-HARQ-RTT-TimerDL for the corresponding HARQ process in the first symbol after the end of the corresponding transmission carrying the DL HARQ feedback;
      3> stop the drx-RetransmissionTimerDL for the corresponding HARQ process
      3> stop the drx-RetransmissionTimerDL-PTM for the corresponding HARQ process.

In an embodiment, the HARQ process/processes that is at least one of configured or assigned for the XR is separate from the HARQ process/processes that is at least one of configured or assigned for the legacy unicast (or non-XR) reception. The MAC entity determines whether the HARQ process for the transmitted MAC PDU in the configured uplink grant is configured or assigned for the XR or the legacy unicast (or non-XR), and accordingly, operate the relevant HARQ RTT timer for uplink and/or DRX retransmission timer for uplink. This is illustrated by an example specification as follows as shown in TABLE 1.

TABLE 1
Example

| 1> | if a MAC PDU is transmitted in a configured uplink grant and LBT failure | |
|---|---|---|
| | indication is not received from lower layers: | |
| | 2> | if the corresponding HARQ process is configured or assigned for XR: |

| | |
|---|---|
| 3> | start the HARQ-RTT-TimerUL-XR for the corresponding HARQ process in |
| | the first symbol after the end of the first transmission (within a bundle) of |
| | the corresponding PUSCH transmission; |
| 3> | stop the drx-RetransmissionTimerUL-XR for the corresponding HARQ |
| | process at the first transmission (within a bundle) of the corresponding |
| | PUSCH transmission. |

| | |
|---|---|
| 2> | else: |

| | |
|---|---|
| 3> | start the drx-HARQ-RTT-TimerUL for the corresponding HARQ process in |
| | the first symbol after the end of the first transmission (within a bundle) of |
| | the corresponding PUSCH transmission; |

| | |
|---|---|
| 3> | stop the drx-RetransmissionTimerUL for the corresponding HARQ process at |

the first transmission (within a bundle) of the corresponding PUSCH transmission.

In an embodiment, if the HARQ-RTT-TimerDL-XR expires and if the data of the corresponding HARQ process was not successfully decoded, the MAC entity starts the drx-RetransmissionTimerDL-XR for the corresponding HARQ process in the first symbol after the expiry of HARQ-RTT-TimerDL-XR.

In an embodiment, if a HARQ-RTT-TimerUL-XR expires, the MAC entity starts the drx-RetransmissionTimerUL-XR for the corresponding HARQ process in the first symbol after the expiry of HARQ-RTT-TimerUL-XR.

In an embodiment, when the UE (100) is configured for the XR service, the received drx-StartOffsetXR and/or drx-SlotOffsetXR is utilized in computing the start of at least one of short DRX cycle and long DRX cycle. Further, a common value for the drx-StartOffsetXR and/or the drx-SlotOffsetXR for all configured XR services is received and applied, or alternatively, specific value(s) for the drx-StartOffsetXR and/or the drx-SlotOffsetXR is/are received for one or more configured XR services and a common value is derived (e.g., the UE (100) derives a common value by considering the largest value(s) e.g., max (drx-StartOffsetXR+drx-SlotOffsetXR) or (drx-StartOffsetXRmax+drx-SlotOffsetXRmax) or max(drx-StartOffsetXR) among all the values of drx-StartOffsetXR and/or drx-SlotOffsetXR received in the positive and negative directions i.e., maximum preponement and maximum deferment). Further, in an embodiment, offset in different activated cells may be different due to different XR services. In order to have the same DRX configuration and/or operation, a common computed or signaled value may be utilized.

TABLE 2
Example

| 1> | if the UE (100) is configured with the XR service: | |
|---|---|---|
| | 2> | if the Short DRX cycle is used for a DRX group, and [(SFN × 10) + subframe |
| | | number] modulo (drx-ShortCycle) = (drx-StartOffset + drx-StartOffsetXR) |
| | | modulo (drx-ShortCycle): |

| | |
|---|---|
| 3> | start drx-onDurationTimer for this DRX group after (drx-SlotOffset + drx- |
| | SlotOffsetXR) from the beginning of the subframe. |

| | 2> | if the Long DRX cycle is used for a DRX group, and [(SFN × 10) + subframe |
|---|---|---|
| | | number] modulo (drx-LongCycle) = drx-StartOffset + drx-StartOffsetXR: |
| 1> | else: | |
| | 2> | if the Short DRX cycle is used for a DRX group, and [(SFN × 10) + subframe |
| | | number] modulo (drx-ShortCycle) = (drx-StartOffset) modulo (drx- |
| | | ShortCycle): |

| | |
|---|---|
| 3> | start drx-onDurationTimer for this DRX group after drx-SlotOffset from the |
| | beginning of the subframe. |

| | |
|---|---|
| 2> | if the Long DRX cycle is used for a DRX group, and [(SFN × 10) + subframe |
| | number] modulo (drx-LongCycle) = drx-StartOffset: |

In an embodiment, a separate retransmission timer (e.g., drx-RetransmissionTimerDL-XR and drx-RetransmissionTimerUL-XR) and RTT timers (drx-HARQ-RTT-TimerDL-XR and drx-HARQ-RTT-TimerUL-XR) are configured for the XR services. These timers are maintained separately for the HARQ processes corresponding to the DL reception with the XR-RNTI or the XR-CS-RNTI.

In an embodiment, when the short DRX is to be utilized (or is configured) for at least one XR service and the legacy unicast (or non-XR service), the network apparatus (200) applies (or the UE (100) computes and applies) the smallest of the short DRX of the at least one of XR service and legacy unicast (or non-XR).

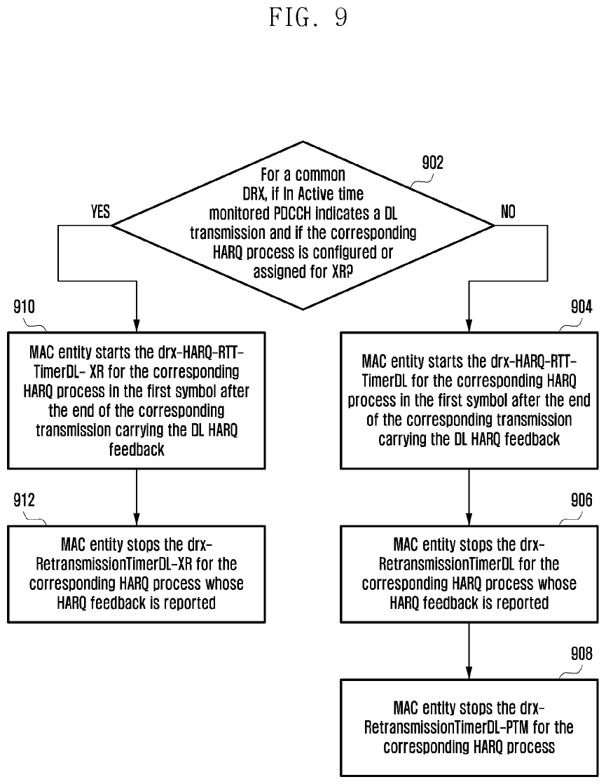

In an embodiment, DRX operation is depicted in FIG. 9 and is illustrated as follows as shown in TABLE 3.

TABLE 3

| 1> | if a DRX group is in Active Time: | |
|---|---|---|
| | 2> | monitor the PDCCH on the Serving Cells in this DRX group as specified in TS |
| | | 38.213; |
| | 2> | if the PDCCH indicates a DL transmission; or |
| | 2> | if the PDCCH indicates a one-shot HARQ feedback as specified in clause 9.1.4 |
| | | of TS 38.213; or |
| | 2> | if the PDCCH indicates a retransmission of HARQ feedback as specified in |
| | | clause 9.1.5 of TS 38.213: |

| | |
|---|---|
| 3> | if the corresponding HARQ process is configured or assigned for XR: |

| | |
|---|---|
| 4> | start the HARQ-RTT-TimerDL-XR for the corresponding HARQ process |
| | in the first symbol after the end of the corresponding transmission |
| | carrying the DL HARQ feedback; |

| | |
|---|---|
| 3> | else: |

| | |
|---|---|
| 4> | start or restart the drx-HARQ-RTT-TimerDL for the corresponding HARQ |
| | process(es) whose HARQ feedback is reported in the first symbol after |
| | the end of the corresponding transmission carrying the DL HARQ |
| | feedback; |

| | |
|---|---|
| 3> | stop the drx-RetransmissionTimerDL or drx-RetransmissionTimerDL-XR |
| | for the corresponding HARQ process(es) whose HARQ feedback is |
| | reported; |
| 3> | stop the drx-RetransmissionTimerDL-PTM for the corresponding HARQ |
| | process; |
| 3> | if the PDSCH-to-HARQ_feedback timing indicate an inapplicable k1 value |
| | as specified in TS 38.213: |

| | |
|---|---|
| 4> | start the drx-RetransmissionTimerDL or drx-RetransmissionTimerDL-XR |
| | in the first symbol after the (end of the last) PDSCH transmission (within |
| | a bundle) for the corresponding HARQ process. |

| | |
|---|---|
| 2> | if the PDCCH indicates a UL transmission: |

| | |
|---|---|
| 3> | if the corresponding HARQ process is configured or assigned for XR: |

| | |
|---|---|
| 4> | start the HARQ-RTT-Timer UL-XR for the corresponding HARQ process |
| | in the first symbol after the end of the first transmission (within a bundle) |
| | of the corresponding PUSCH transmission; |

| | |
|---|---|
| 3> | else: |

| | |
|---|---|
| 4> | start the drx-HARQ-RTT-TimerUL for the corresponding HARQ process |
| | in the first symbol after the end of the first transmission (within a bundle) |
| | of the corresponding PUSCH transmission; |

| | |
|---|---|
| 3> | stop the drx-RetransmissionTimerUL or drx-RetransmissionTimerUL-XR |
| | for the corresponding HARQ process. |

| | |
|---|---|
| 2> | if the PDCCH indicates a new transmission (DL, UL or SL) on a Serving Cell |
| | in this DRX group: |

| | |
|---|---|
| 3> | start or restart drx-InactivityTimer for this DRX group in the first symbol |
| | after the end of the PDCCH reception. |

The PDCCH indicating activation of the SPS, configured grant type 2, configured XR grant of configured grant Type 2 or configured sidelink grant of configured grant Type 2 is considered to indicate a new transmission as shown in TABLE 4.

TABLE 4

| 2> | if a HARQ process receives downlink feedback information and | |
|---|---|---|
| | acknowledgement is indicated: | |
| | 3> | stop the drx-RetransmissionTimerUL or drx-RetransmissionTimerUL-XR |
| | | for the corresponding HARQ process. |

In an embodiment, the MAC entity of the UE (100) may have separate XR configuration of one or more XR services for DRX on-duration timer, DRX inactivity timer, RTT timer (i.e., drx-HARQ-RTT-TimerDL-XR and/or drx-HARQ-RTT-TimerUL-XR) and/or Retransmission timer (i.e., drx-RetransmissionTimerDL-XR and/or drx-RetransmissionTimerUL-XR) than the unicast DRX configuration.

In an embodiment, an example specification text is provided illustrating the operational details for one or more XR DRX configurations. The one or more XR DRX configurations can be additional and/or independent to the unicast (or non-XR) DRX configuration.

Discontinuous reception (DRX) for XR: For the XR, the MAC entity may be configured by RRC with a DRX functionality per XR-RNTI or per XR-CS-RNTI that controls the UE's PDCCH monitoring activity for the MAC entity's XR-RNTI(s) and XR-CS-RNTI(s) as specified in TS 38.331. When in RRC_CONNECTED, if XR DRX is configured, the MAC entity is allowed to monitor the PDCCH for this XR-RNTI or XR-CS-RNTI discontinuously using the XR DRX operation specified in this clause; else, the MAC entity monitors the PDCCH for this XR-RNTI or XR-CS-RNTI as specified in TS 38.213. The XR DRX operation specified in this clause is performed independently for each XR-RNTI or XR-CS-RNTI and independently from the DRX operation specified in 3GPP standard specification.

The RRC controls the operation of the XR DRX per XR-RNTI or per XR-CS-RNTI by configuring the following parameters:
a. drx-onDurationTimerXR: the duration at the beginning of a DRX cycle or an adjusted DRX cycle, if any;
b. drx-SlotOffsetXR-static: the delay before starting the drx-onDurationTimerXR;
c. drx-InactivityTimerXR: the duration after the PDCCH occasion in which a PDCCH indicates a new DL or UL XR transmission for the MAC entity;
d. drx-LongCycleStartOffsetXR: the long DRX cycle drx-LongCycle-XR and drx-StartOffset-XR-static which defines the subframe where the long DRX cycle starts;
e. drx-RetransmissionTimerDL-XR (per DL HARQ process for XR): the maximum duration until a DL XR retransmission is received;
f. drx-HARQ-RTT-TimerDL-XR (per DL HARQ process for XR): the minimum duration before a DL XR assignment for HARQ retransmission is expected by the MAC entity;
g. drx-RetransmissionTimer UL-XR (per UL HARQ process): the maximum duration until a grant for UL retransmission is received;
h. drx-HARQ-RTT-TimerUL-XR (per UL HARQ process): the minimum duration before a UL HARQ retransmission grant is expected by the MAC entity; and
i. ps-WakeupXR (optional): the configuration to start associated drx-onDurationTimerXR in case DCP is monitored but not detected.

In an embodiment, the parameter drx-StartOffsetXR and/or drx-SlotOffsetXR may be signaled to the UE (100) dynamically by the network apparatus (200) by utilizing at least one of downlink control information (DCI, e.g., a scheduling DCI), a presence or absence or location and/or embedded information (e.g., PDCCH based signaling) of the wakeup signal (WUS), a presence or absence and/or location of the wakeup radio (WUR) sequence/pattern or a MAC control element (CE). The parameter drx-StartOffsetXR and/or drx-SlotOffsetXR may be associated to the one or more specific XR service(s) (e.g., XR-RNTI or XR-CS-RNTI) or is applicable collectively for all the configured XR service(s). Identification of drx-StartOffsetXR and/or drx-SlotOffsetXR parameter for a specific XR service is through at least one of associated DCI, WUS, WUR or MAC CE addressed to (or scrambled by) XR-RNTI or XR-CS-RNTI, or associated DCI, WUS, WUR or MAC CE carrying XR service field information. The drx-StartOffsetXR and/or the drx-slotOffsetXR may be applicable or valid for one or more DRX cycles and the validity duration may also be indicated or configured to the UE (100).

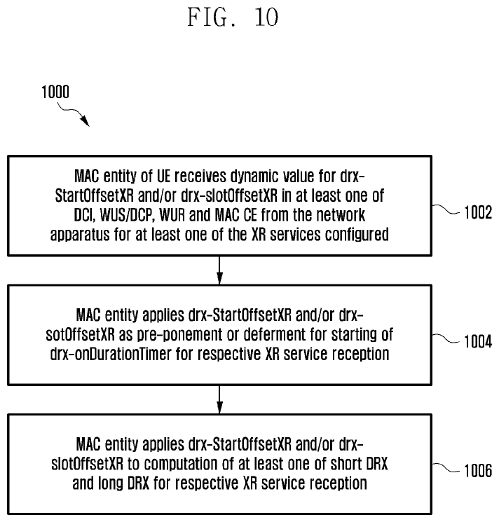

Further, the drx-StartOffsetXR and/or the drx-slotOffsetXR may be defined and configured separately for short DRX cycle as drx-StartOffsetXR-shortDRX and/or drx-slotOffsetXR-shortDRX” and/or Long DRX cycle as “drx-StartOffsetXR-longDRX and/or drx-slotOffsetXR-LongDRX” or as a common parameter “drx-StartOffsetXR and/or drx-slotOffsetXR” for short DRX cycle and/or Long DRX cycle. In an alternate embodiment, a set of values for the drx-StartOffsetXR and/or drx-slotOffsetXR for one or more XR services is configured by the network apparatus (200) through RRC (re-)configurations and the UE (100) applies the configured value to advance or delay the starting of drx-onDurationTimer based on reception of the DCI, the WUS, the WUR or the MAC CE scrambled using the XR-RNTI or XR-CS-RNTI e.g., receiving an index to the set of values configured or a bitmap or a field representing the configured value to be applied. This is illustrated in FIG. 10.

In an example, the below is an example for the dynamic parameter:
a. drx-StartOffsetXR: the preponement or the deferment for starting the drx-onDurationTimerXR in number of sub-frames or milliseconds; and
b. drx-SlotOffsetXR: the preponement or the deferment for starting the drx-onDurationTimerXR in number of slots or sub-milliseconds.

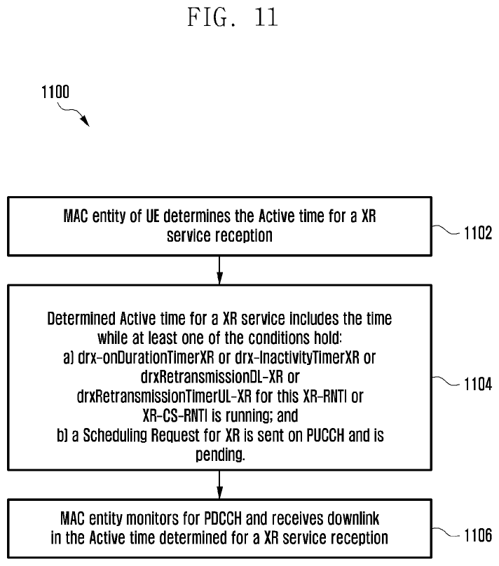

In an embodiment, when XR DRX is configured for a XR-RNTI or XR-CS-RNTI, the Active Time includes the time while drx-onDurationTimerXR or drx-InactivityTimerXR or drx-RetransmissionTimerDL-XR or drx-RetransmissionTimerUL-XR for this XR-RNTI or XR-CS-RNTI is running or a Scheduling Request for XR is sent on PUCCH and is pending. This is illustrated in FIG. 11.

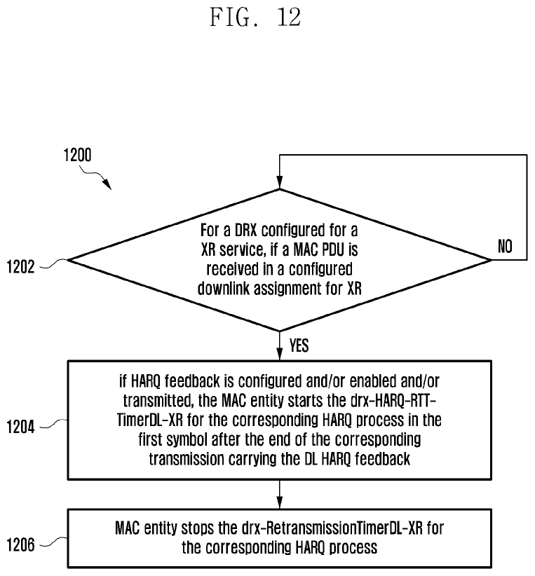

In an embodiment, if a MAC PDU is received in a configured downlink assignment for XR and if HARQ feedback is configured and/or enabled and/or transmitted, MAC entity starts the drx-HARQ-RTT-TimerDL-XR for the corresponding HARQ process in the first symbol after the end of the corresponding transmission carrying the DL HARQ feedback. This is depicted in FIG. 12.

When the XR DRX is configured for the XR-RNTI or the XR-CS-RNTI, the MAC entity may for the XR-RNTI or XR-CS-RNTI as shown in TABLE 5.

TABLE 5

| 1> | if a MAC PDU is received in a configured downlink assignment for XR: | |
|---|---|---|
| | 2> | if HARQ feedback is configured and/or enabled and/or transmitted: |

| | |
|---|---|
| 3> | start the drx-HARQ-RTT-TimerDL-XR for the corresponding HARQ process |
| | in the first symbol after the end of the corresponding transmission carrying |
| | the DL HARQ feedback; |

| | 2> | stop the drx-RetransmissionTimer DL-XR for the corresponding HARQ process; |
|---|---|---|
| 1> | if a drx-HARQ-RTT-TimerDL-XR expires: | |
| | 2> | if the data of the corresponding HARQ process was not successfully decoded: |

| | |
|---|---|
| 3> | start the drx-RetransmissionTimerDL-XR for the corresponding HARQ |
| | process in the first symbol after the expiry of drx-HARQ-RTT-TimerDL-XR. |

In an embodiment, starting of the drx-onDurationTimerXR is provided. If the dynamic parameters drx-StartOffsetXR and/or drx-SlotffsetXR is/are provided for the XR service (e.g., addressed by XR-RNTI or XR-CS-RNTI), prepone or defer the start of drx-onDurationTimerXR based on drx-StartOffsetXR and/or drx-SlotOffsetXR.

TABLE 6
Example

Example:

| | |
|---|---|
| 1> | if the Short DRX cycle is used for a DRX group, and [(SFN × 10) + subframe |
| | number] modulo (drx-ShortCycle-XR) = (drx-StartOffset-XR-static + drx- |
| | StartOffsetXR) modulo (drx-ShortCycle): |
| 2> | start drx-onDurationTimer for this DRX group after (drx-SlotOffset-XR-static + |
| | drx-SlotOffset-XR) from the beginning of the subframe. |
| 1> | if [(SFN × 10) + subframe number] modulo (drx-LongCycle-XR) = drx- |
| | StartOffset-XR-static + drx-StartOffset-XR: |
| 2> | start drx-onDurationTimerXR after drx-SlotOffsetXR-static + drx-SlotOffset-XR |
| | from the beginning of the subframe. |

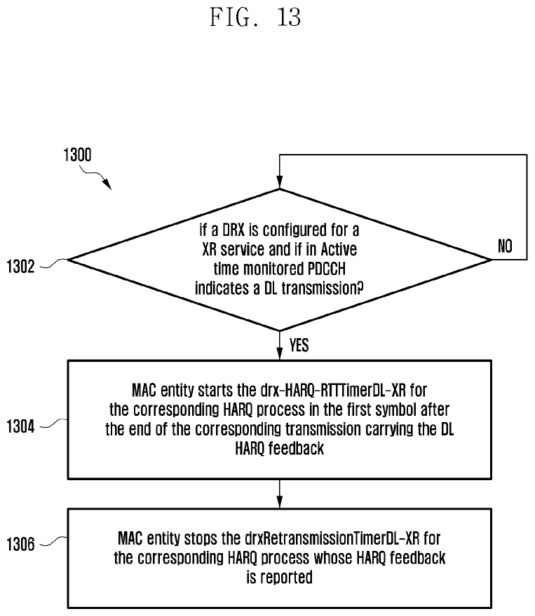

In an embodiment, if the PDCCH indicates a DL XR transmission and if HARQ feedback is configured and/or enabled and/or transmitted, MAC entity starts the drx-HARQ-RTT-TimerDL-XR for the corresponding HARQ process in the first symbol after the end of the corresponding transmission carrying the DL HARQ feedback. Further MAC entity stops the drx-RetransmissionTimerDL-XR for the corresponding HARQ process. This is depicted in FIG. 13.

In an embodiment, if the PDCCH indicates a UL XR transmission, the MAC entity starts the drx-HARQ-RTT-TimerUL-XR for the corresponding HARQ process in the first symbol after the end of the first transmission (within a bundle) of the corresponding PUSCH transmission and stops the drx-RetransmissionTimerUL-XR for the corresponding HARQ process as shown in TABLE 7.

TABLE 7
Example

| 1> | if the MAC entity is in Active Time for this XR-RNTI or XR-CS-RNTI: | |
|---|---|---|
| | 2> | monitor the PDCCH for this XR-RNTI or XR-CS-RNTI as specified in TS |
| | | 38.213; |
| | 2> | if the PDCCH indicates a DL XR transmission: |

| | |
|---|---|
| 3> | if HARQ feedback is configured and/or enabled and/or transmitted: |

| | |
|---|---|
| 4> | start the drx-HARQ-RTT-TimerDL-XR for the corresponding HARQ |
| | process in the first symbol after the end of the corresponding |
| | transmission carrying the DL HARQ feedback; |

| | |
|---|---|
| 3> | stop the drx-RetransmissionTimerDL-XR for the corresponding HARQ |
| | process; |

| | |
|---|---|
| 2> | if the PDCCH indicates a new XR transmission (DL or UL) for this XR-RNTI |
| | or XR-CS-RNTI: |

| | |
|---|---|
| 3> | start or restart drx-InactivityTimerXR for this XR-CRNTI or XR-CS-RNTI |
| | in the first symbol after the end of the PDCCH reception. |

The PDCCH indicating activation of XR SPS or configured XR grant type 2 is considered to indicate a new transmission as shown in TABLE 8.

TABLE 8

| 2> | if the PDCCH indicates a UL transmission: | |
|---|---|---|
| | 3> | start the drx-HARQ-RTT-TimerUL-XR for the corresponding HARQ process |
| | | in the first symbol after the end of the first transmission (within a bundle) of |
| | | the corresponding PUSCH transmission; |
| | 3> | stop the drx-RetransmissionTimerUL-XR for the corresponding HARQ |
| | | process. |
| 2> | if a HARQ process receives downlink feedback information and | |
| | acknowledgement is indicated for this XR-RNTI or XR-CS-RNTI: | |
| | 3> | stop the drx-RetransmissionTimerUL-XR for this XR-RNTI or XR-CS- |
| | | RNTI for the corresponding HARQ process. |

The MAC entity need not monitor the PDCCH for a XR-RNTI or a XR-CS-RNTI if it is not a complete PDCCH occasion (e.g., the active time for the XR-RNTI or the XR-CS-RNTI starts or ends in the middle of a PDCCH occasion).

Alternatively, in an embodiment, the network apparatus (200) configures the UE (100) with the multiple DRX configuration parameters such as drx-OnDurationTimer, drx-inactivityTimer, RTT timer, and the retransmission timer. The XR sessions are associated with one of the DRX configuration. The network apparatus (200) signals which DRX configuration to use to monitor the PDCCH and the offset to apply for starting corresponding drx-OnDurationTimer through at least one of the DCI, the WUS, the WUR sequence and the MAC CE.

In an embodiment, when the PDCCH search space for the XR and other legacy services are separate and the UE (100) is configured with different DRX configuration for the XR as in any of the above embodiments, the UE (100) monitors the PDCCH search space of the XR only and does not monitor the PDCCH search space for other services during the DRX Active Time for the XR.

In an embodiment, if there are one or more DRX configurations for each XR service, the UE (100) monitors only the PDCCH search space for the XR service during the DRX active time for that service. If some of the XR services share the same DRX configuration, the UE (100) monitors the PDCCH search space for only those XR services during the DRX Active Time for those services.

In an embodiment, the UE (100) indicates the capability to support the multiple DRX configuration through at least one of UE capability exchange procedure and a UE assistance information. The UE (100) also indicates whether the UE (100) supports the power saving preference for the XR. In an example, the drx-preferenceXR included in PowSav-Parameters in the UE capability message indicates the support for the power saving preferences for the XR. Further, the UE (100) can be configured with the DRX-PreferenceConfig-XR by the network apparatus (200) to allow to provide the UE assistance information about the UE's XR DRX preferences for the power saving, along with a prohibit timer to control the reporting frequency. The UE (100) also indicates the maximum number of DRX configurations the UE can support. In another embodiment, the UE indicates the preference in UE assistance information, at least one of or combination of:
a) Common DRX configuration for legacy unicast and XR services,
b) Separate DRX configurations for legacy unicast and XR services, and/or
c) Common or per service, preferred RTT and retransmission timer value for XR services.

In an embodiment, a MAC-CellGroupConfig message which is used to configure MAC parameter for a cell group comprises of setup or release drx-ConfigXR for one or more XR services if cell group supports XR and may include the XR DRX configuration parameters for at least one of drx-onDurationTimerXR, drx-inactivityTimerXR, drx-HARQ-RTT-TimerUL-XR, drx-HARQ-RTT-TimerDL-XR, drx-RetransmissionTimerUL-XR, drx-RetransmissionTimerDL-XR, drx-SlotOffsetXR-static, drx-Shortcycle-XR, drx-ShortcycleTimer-XR, drx-LongCycle-XR, and drx-StartOffsetXR-static.

In an embodiment, the MAC-CellGroupConfig message which is used to configure MAC parameter for the cell group includes a setup or release of drx-Config and/or drx-ConfigSecondaryGroup for the legacy unicast which may be shared for the XR reception and with additionally including at least one DRX parameters for XR reception such as drx-HARQ-RTT-TimerUL-XR, drx-HARQ-RTT-TimerDL-XR, drx-RetransmissionTimerUL-XR, drx-RetransmissionTimerDL-XR, drx-Shortcycle-XR, and drx-ShortcycleTimer-XR.

In an embodiment, there may be one or more DRX configurations are applied for one or more XR flows or streams or frame types of the XR service(s) and the DRX configurations may be switched across among multiple DRX configurations (e.g., a different DRX config at a different time) and applicable DRX config is indicated by at least one of the DCI, the WUS, the WUR or the MAC CE (e.g., using a bitmap or index of the applicable DRX config). The RNTI used for one or more XR DRX configuration and/or XR reception can be one of C-RNTI or XR-RNTI or multiple XR-RNTIs. The indicated DRX configuration may be applicable for a stipulated time and/or until a new DRX config is indicated. The multiple DRX configurations may differ in at least one parameter including drx-onDurationTimerXR, drx-inactivityTimerXR, drx-HARQ-RTT-TimerUL-XR, drx-HARQ-RTT-TimerDL-XR, drx-RetransmissionTimerUL-XR, drx-RetransmissionTimerDL-XR, drx-SlotOffsetXR-static, drx-Shortcycle-XR, drx-ShortcycleTimer-XR, drx-LongCycle-XR, and drx-StartOffsetXR-static. In another embodiment, one or more DRX configurations may be operated in parallel.

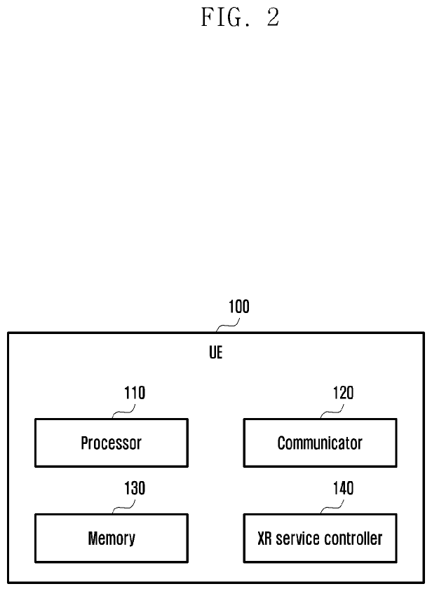

FIG. 2 illustrates various hardware components of the UE (100) according to the embodiments as disclosed herein. In an embodiment, the UE (100) includes a processor (110), a communicator (120), a memory (130) and a XR service controller (140). The processor (110) is coupled with the communicator (120), the memory (130) and the XR service controller (140).

The XR service controller (140) determines whether the radio bearer configuration includes the identifier field as “isXR bearer” field. In an embodiment, upon determining that the radio bearer configuration includes the “isXR bearer” field, the XR service controller (140) identifies the radio bearer pertaining to the XR service. In another embodiment, upon determining that the radio bearer configuration does not includes the “isXR bearer” field, the XR service controller (140) identifies the radio bearer not pertaining to the XR service.

In an embodiment, the XR service controller (140) further receives a configurable value or the dynamic value for at least one of the drx-StartOffsetXR and the drx-slotOffsetXR in at least one of the DCI, the WUS, the DCP, the WUR, the MAC CE and the RRC signalling from the network apparatus (200) for the XR service. The configurable value is provided to the UE (100) through RRC signaling. The configurable value may be a set of one or more preconfigured values that can be static or semi-static in nature. The dynamic value may be an index to a configurable value and can typically be provided through a faster signaling mechanism e.g., MAC CE or DCI and a dynamic value can be provided to whenever there is a need to change the value of the offset to be applied.

Further, the XR service controller (140) applies at least one of the drx-StartOffsetXR and the drx-slotOffsetXR as the pre-ponement or the deferment for starting of the drx-onDurationTimer for the XR service reception. Further, the XR service controller (140) applies at least one of the drx-StartOffsetXR and the drx-slotOffsetXR to computation of at least one of the short DRX and the long DRX for the XR service reception. The short DRX typically involves a short DRX cycle to enable faster turnaround from a DRX sleep state to a DRX ON state and thereby, lower latency can be supported. The long DRX typically involves a long DRX to facilitate higher power saving, through at cost of higher latency due to longer turnaround from the DRX sleep state to the DRX ON state.

In an embodiment, the XR service controller (140) further receives the RRC re-configuration message including the set of configured values for at least one of the drx-StartOffsetXR and the drx-slotOffsetXR. Further, the XR service controller (140) applies at least one value from the set of configured values to change the starting of the drx-onDurationTimer based on indication from at least one of the DCI, the WUS, the DCP, the WUR and the MAC CE scrambled using at least one of the XR-RNTI, the XR-CS-RNTI, the C-RNTI and the CS-RNTI for reception of the XR service. The at least one value from the set of configured values is indicated by the index to the set of configured values or the bitmap or the field representing the configured value to be applied.

In an embodiment, the XR service controller (140) further configures the UE (100) with the at least one DRX configuration parameter from multiple DRX configurations. The at least one DRX configuration parameter includes the drx-OnDurationTimer, the drx-inactivityTimer, the RTT timer, and the retransmission timer. The network apparatus configures the UE (100) with the at least one DRX configuration parameter from the multiple DRX configurations. Further, the XR service controller (140) associates the DRX configuration from the multiple DRX configurations with the XR session for the XR service based on the at least one DRX configuration parameter.

In an embodiment, the XR service controller (140) further determines whether there is at least one DRX configuration for the XR service during the DRX Active Time. Further, the XR service controller (140) monitors the PDCCH search space for the XR service during the DRX Active Time.

In an embodiment, the XR service controller (140) further indicates the capability to support multiple DRX configurations through at least one of the UE capability information exchange procedure and the UE assistance information. In another embodiment, the XR service controller (140) further indicates whether the UE (100) supports the power saving preference for the XR in the UE capability message. In another embodiment, the XR service controller (140) further indicates the maximum number of DRX configurations that the UE (100) supports.

In an embodiment, the XR service controller (140) further indicates the preference of at least one of the common DRX configuration for the legacy unicast and the XR service, the separate DRX configurations for the legacy unicast and the XR service, the common DRX configuration or the per service DRX configuration, the preferred RTT timer value and the preferred retransmission timer value for the XR services in the UE assistance information.

In an embodiment, the XR service controller (140) further identifies whether at least two DRX configurations are applied for the one or more XR service reception. Further, the XR service controller (140) switches among the at least two DRX configurations from the multiple DRX configurations. Further, the XR service controller (140) receives the indication of the suitable DRX configuration among the at least two DRX configurations for the XR reception using at least one of the DCI, the WUS, the WUR and the MAC CE. The indicated DRX configuration is applicable for a predefined time. The predefined time is set by the UE (100) and/or the network apparatus (200). The DRX configuration differ in at least one parameter including at least one of the drx-onDurationTimer, the drx-inactivityTimer, the drx-HARQ-RTT-TimerUL, the drx-HARQ-RTT-TimerDL, the drx-RetransmissionTimerUL, the drx-RetransmissionTimerDL, the drx-SlotOffsetXR, the drx-SlotOffsetXR-static, the drx-Shortcycle, the drx-ShortcycleTimer, the drx-LongCycle, the drx-StartOffsetXR and the drx-StartOffsetXR-static.

In an embodiment, the XR service controller (140) further receives the MAC CellGroupConfig message. The MAC CellGroupConfig message configures the MAC parameter for a cell group including at least one of the setup of drx-Config, the setup of drx-ConfigSecondaryGroup, the release of drx-Config and the release of drx-ConfigSecondaryGroup for at least one of the legacy unicast and the XR service reception.

The XR service controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 2 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the present disclosure. One or more components can be combined together to perform same or substantially similar function in the UE (100).

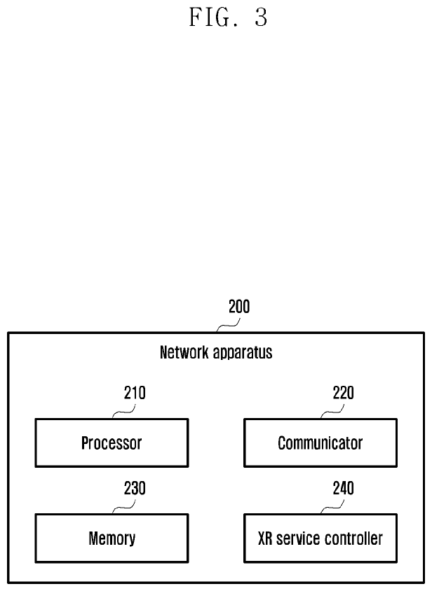

FIG. 3 illustrates various hardware components of the network apparatus (200) according to the embodiments as disclosed herein. The network apparatus (200) includes a processor (210), a communicator (220), a memory (230) and a XR service controller (240). The processor (210) is coupled with the communicator (220), the memory (230) and the XR service controller (240).

The XR service controller (240) sends the radio bearer configuration including the identifier field as “isXR bearer” field to identify the radio bearer pertaining to the XR service to the UE (100) in the wireless network (300). Based on the radio bearer configuration including the “isXR bearer” field, the XR service controller (240) manages the XR service in the wireless network (300).

In an embodiment, the XR service controller (240) further sends the configurable value or the dynamic value for at least one of the drx-StartOffsetXR and the drx-slotOffsetXR in at least one of the DCI, the WUS, the DCP, the WUR, the MAC CE and the RRC) signalling to the UE (100) for the XR service.

In another embodiment, the XR service controller (240) further sends the RRC re-configuration message comprising the set of configured values for at least one of the drx-StartOffsetXR and the drx-slotOffsetXR to the UE (100) for the XR service. In another embodiment, the XR service controller (240) further configures the UE (100) with the DRX configuration parameter from the multiple DRX configurations.

The XR service controller (240) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

Although the FIG. 3 shows various hardware components of the the network apparatus (200) but it is to be understood that other embodiments are not limited thereon. In other embodiments, the the network apparatus (200) may include less or more number of components. Further, the labels or names of the components are used only for illustrative purpose and does not limit the scope of the present disclosure. One or more components can be combined together to perform same or substantially similar function in the the network apparatus (200).

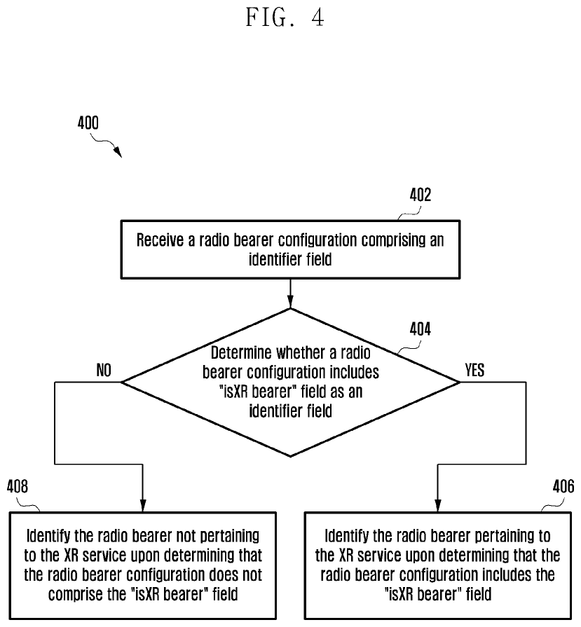

FIG. 4 illustrates a flowchart (400) of method, implemented by the UE (100), for managing power saving for the XR service in the wireless network (300) according to the embodiments as disclosed herein. The operations (402-408) are handled by the XR service controller (140).

At S402, the method includes receiving the radio bearer configuration comprising the identifier field. At step 404, the method includes determining whether the radio bearer configuration includes the “isXR bearer” field as the identifier field. At step 406, the method includes identifying the radio bearer pertaining to the XR service upon determining that the radio bearer configuration includes the “isXR bearer” field. At step 408, the method includes identifying the radio bearer not pertaining to the XR service upon determining that the radio bearer configuration does not include the “isXR bearer” field.

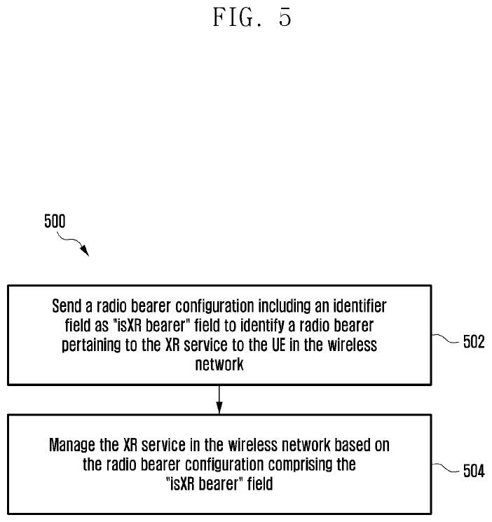

FIG. 5 illustrates a flowchart (500) of method for managing power saving for the XR service in the wireless network (300) according to embodiments as disclosed herein. The operations (502-504) are handled by the XR service controller (240).

At step 502, the method includes sending the radio bearer configuration including the identifier field as “isXR bearer” field to identify the radio bearer pertaining to the XR service to the UE (100) in the wireless network (300). At step 504, the method includes managing the XR service in the wireless network (504) based on the radio bearer configuration including the “isXR bearer” field.

Based on the provided method, the enhanced DRX mechanism ensures power saving as well as low latency for the XR packets transfer. Thus, results in enhancing the user experience and UE/network performance.

FIG. 6 illustrates a flowchart (600) of a configurable or the dynamic offset operation to the common DRX for the XR and the legacy unicast/non-XR reception according to embodiments as disclosed herein. The operations (602-606) are handled by the XR service controller (140).

At step 602, the MAC entity of the UE (100) receives a configurable value or a dynamic value for the drx-StartOffsetXR and the drx-slotOffsetXR in at least one of the DCI, the WUS, the DCP, the WUR, the MAC CE and RRC signaling from the network apparatus (200). At step 604, the MAC entity applies the drx-StartOffsetXR and the drx-slotOffsetXR as the pre-ponement or the deferment for starting of the drx-onDurationTimer “commonly” for one or more XR services reception and legacy unicast or non-XR service reception. At step 606, the MAC entity applies the drx-StartOffsetXR and the drx-slotOffsetXR to computation of at least one of short DRX and long DRX “commonly” for one or more XR service reception and legacy unicast or non-XR service reception.

FIG. 7 illustrates a flowchart of an operational flow for Active time determination for the common DRX for the XR and legacy unicast/non-XR reception according to embodiments as disclosed herein. The operations (702-706) are handled by the XR service controller (140).

At step 702, the MAC entity of the UE (100) determines the active time of the common DRX for one or more XR services reception and legacy unicast/non-XR reception. At step 704, the MAC entity of the UE (100) determines the active time including the time while at least one of the conditions hold such as drx-onDurationTimer or drx-InactivityTimer configured for the DRX group is running (considering offset of drx-StartOffsetXR and/or drx-slotOffsetXR when XR is configured), or drx-RetransmissionTimerDL, drx-RetransmissionTimerUL, drx-RetransmissionTimerDL-XR, drx-RetransmissionTimerUL-XRor drx-RetransmissionTimerSL is running on any serving cell in the DRX group, or ra-ContentionResolutionTimer or msgB-ResponseWindow is running, or a scheduling request is sent on PUCCH and is pending, or a PDCCH indicating a new transmission addressed to the C-RNTI of the MAC entity has not been received after successful reception of a random access response for the random access preamble not selected by the MAC entity among the contention-based random access preamble. At step 706, MAC entity of the UE (100) monitors for PDCCH and receives downlink in the determined Active time for one or more XR services reception and legacy unicast/non-XR reception.

FIG. 8 illustrates a flowchart (800) of an operational flow for the DRX timers operation for the common DRX for the XR and legacy unicast/non-XR reception when the MAC PDU is received in the configured downlink assignment according to embodiments as disclosed herein. The operations (802-812) are handled by the XR service controller (140).

At step 802, the method includes determining whether the MAC PDU is received in the configured downlink assignment and if the corresponding HARQ process is configured or assigned for the XR for the common DRX. Upon determining that the MAC PDU is not received in the configured downlink assignment and if the corresponding HARQ process is not configured or assigned for the XR for the common DRX then, At step 804, the MAC entity starts the drx-HARQ-RTT TimerDL for the corresponding HARQ process in the first symbol after the end of the corresponding transmission carrying the DL HARQ feedback. At step 806, the MAC entity stops the drx-RetransmissionTimerDL for the corresponding HARQ process. At step 808, the MAC entity stops the drx-RetransmissionTimerDL-PTM for the corresponding HARQ process.

Upon determining that the MAC PDU is received in the configured downlink assignment and if the corresponding HARQ process is configured or assigned for the XR for the common DRX, then, at step 810, the MAC entity starts the drx-HARQ-RTT TimerDL-XR for the corresponding HARQ process in the first symbol after the end of the corresponding transmission carrying the DL HARQ feedback. At step 812, the MAC entity stops the drx-RetransmissionTimerDL-XR for the corresponding HARQ process.

FIG. 9 illustrates a flowchart (900) of an operational flow for the DRX timers operation for the common DRX for the XR and legacy unicast/non-XR reception when the PDCCH indicates the DL transmission according to embodiments as disclosed herein. The operations (902-912) are handled by the XR service controller (140).

At step 902, for the common DRX, the method includes determining whether an in-Active time monitored PDCCH indicates the DL transmission and if the corresponding HARQ process is configured or assigned for the XR. Upon determining whether the in-Active time monitored PDCCH does not indicate the DL transmission and if the corresponding HARQ process is not configured or assigned for the XR then, at step 904, the MAC entity starts the drx-HARQ-RTT-TimerDL for the corresponding HARQ process in the first symbol after the end of the corresponding transmission carrying the DL HARQ feedback. At step 906, the MAC entity stops the drx-RetransmissionTimerDL for the corresponding HARQ process whose HARQ feedback is reported. At step 908, the MAC entity stops the drx-RetransmissionTimerDL-PTM for the corresponding HARQ process.

Upon determining that the in-Active time monitored PDCCH indicates the DL transmission and if the corresponding HARQ process is configured or assigned for the XR then, at step 910, the MAC entity starts the drx-HARQ-RTT-TimerDL-XR for the corresponding HARQ process in the first symbol after the end of the corresponding transmission carrying the DL HARQ feedback. At step 912, the MAC entity stops the drx-RetransmissionTimerDL-XR for the corresponding HARQ process whose HARQ feedback is reported.

FIG. 10 illustrates a flowchart (1000) of the dynamic offset operation to the DRX for the XR service reception according to embodiments as disclosed herein. The operations (1002-1006) are handled by the XR service controller (140).

At step 1002, the MAC entity of the UE (100) receives the dynamic value for the drx-StartOffsetXR and/or the drx-slotOffsetXR in at least one of the DCI, the WUS, the DCP, the WUR and the MAC CE from the network apparatus (200) for the at least one XR services configured. At step 1004, the MAC entity of the UE (100) applies the drx-StartOffsetXR and/or the drx-slotOffsetXR as pre-ponement or deferment for starting of drx-onDurationTimer for respective XR service reception. At step 1006, the MAC entity of the UE (100) applies the drx-StartOffsetXR and/or drx-slotOffsetXR to computation of at least one of short DRX and long DRX for respective XR service reception.

FIG. 11 illustrates a flowchart (1100) of an operational flow for the Active time determination for the XR service reception according to embodiments as disclosed herein. The operations (1102-1106) are handled by the XR service controller (140).

At step 1102, the MAC entity of the UE (100) determines the active time for the XR service reception. At step 1104, the MAC entity of the UE (100) determines the active time for the XR service including the time while at least one of the conditions hold such as drx-onDurationTimerXR or drx-InactivityTimerXR or drx-RetransmissionTimerDL-XR or drxRetransmissionTimerUL-XR for the XR-RNTI or XR-CS-RNTI is running, and a scheduling request for XR is sent on PUCCH and is pending. At step 1106, the MAC entity of the UE (100) monitors for PDCCH and receives downlink in the Active time determined for a XR service reception.

FIG. 12 illustrates a flowchart (1200) of an operational flow for DRX timers operation for the DRX for the XR service reception when the MAC PDU is received in the configured downlink assignment according to embodiments as disclosed herein. The operations (1202-1206) are handled by the XR service controller (140).

At step 1202, for the DRX configured for the XR service, the MAC entity determines that the MAC PDU is received in the configured downlink assignment for the XR. Upon determining that the MAC PDU is received in the configured downlink assignment for the XR then, at step 1204, if the HARQ feedback is configured and/or enabled and/or transmitted, the MAC entity starts the drx-HARQ-RTT-TimerDL-XR for the corresponding HARQ process in the first symbol after the end of the corresponding transmission carrying the DL HARQ feedback. Upon determining that the MAC PDU is not received in the configured downlink assignment for the XR then, the operation loops back to step 1202. At step 1206, the MAC entity stops the drx-RetransmissionTimerDL-XR for the corresponding HARQ process.

FIG. 13 illustrates a flowchart (1300) of an operational flow for DRX timers operation for the DRX for the XR service reception when the PDCCH indicates the DL transmission according to embodiments as disclosed herein. The operations (1302-1306) are handled by the XR service controller (140).

At step 1302, the UE (100) determines that if the DRX is configured for the XR service and if in active time monitored PDCCH indicates the DL transmission. Upon determining the DRX is configured for the XR service and if in active time monitored PDCCH indicates the DL transmission then, at step 1304, the MAC entity starts the drx-HARQ-RTTTimerDL-XR for the corresponding HARQ process in the first symbol after the end of the corresponding transmission carrying the DL HARQ feedback. Upon determining that the DRX is not configured for the XR service and if in active time monitored PDCCH does not indicate the DL transmission then, the operation loops back to step 1302. At step 1306, the MAC entity stops the drx-RetransmissionTimerDL-XR for the corresponding HARQ process whose HARQ feedback is reported.

According to an embodiment, a method performed by a user equipment (UE) in a communication system may be provided.

According to an embodiment, the method may include receiving, a radio bearer configuration including an identifier field.

According to an embodiment, the method may include determining whether the radio bearer configuration includes an isXR bearer field as the identifier field.

According to an embodiment, identifying one of: the radio bearer pertaining to an extended reality (XR) service based on a determination that the radio bearer configuration includes the isXR bearer field, or the radio bearer not pertaining to the XR service based on a determination that the radio bearer configuration does not include the isXR bearer field.

According to an embodiment, the method may include receiving a configurable value associated with the XR service or a dynamic value associated with the XR service for at least one of a drx-StartOffsetXR or a drx-slotOffsetXR in at least one of downlink control information (DCI), a wakeup signal (WUS), DCI with cyclic redundancy check (CRC) scrambled with a power saving-radio network temporary identifier (PS-RNTI) (DCP), a wakeup radio (WUR), a medium access control control element (MAC CE), or radio resource control (RRC) signalling from a network apparatus for at least one XR service.

According to an embodiment, the method may include applying at least one of the drx-StartOffsetXR or the drx-slotOffsetXR as a pre-ponement or a deferment for starting of a drx-onDurationTimer for a XR service reception.

According to an embodiment, the method may include applying at least one of the drx-StartOffsetXR or the drx-slotOffsetXR for computing at least one of a short discontinuous reception (DRX) or a long DRX for the XR service reception.

According to an embodiment, wherein at least one of the XR service reception or a XR service transmission may be performed with re-utilizing at least one of a cell radio network temporary identifier (C-RNTI) or a configured scheduling radio network temporary identifier (CS-RNTI) of a unicast reception or a unicast transmission.

According to an embodiment, wherein the XR service may use at least one of a C-RNTI or a CS-RNTI when the XR service is multiplexed on a same medium access control protocol data unit (MAC PDU) with at least one of a non-XR service or a legacy unicast.

According to an embodiment, the method may include receiving a radio resource control (RRC) re-configuration message including a set of configured values for at least one of a drx-StartOffsetXR or a drx-slotOffsetXR.

According to an embodiment, the method may include applying at least one value from the set of configured values to change a starting instance of a drx-onDurationTimer based on an indication from at least one of a DCI, a WUS, a DCP, a WUR and a MAC CE scrambled using at least one of an XR-RNTI, a XR-CS-RNTI, a C-RNTI or a CS-RNTI for a reception of the XR service.

According to an embodiment, wherein the at least one value from the set of configured values may be indicated by an index to the set of configured values or a bitmap or a field representing the configured value to be applied.

According to an embodiment, the method may include receiving information to configure the UE with at least one DRX configuration parameter from multiple DRX configurations, wherein the at least one DRX configuration parameter includes at least one of a drx-OnDurationTimer, a drx-inactivityTimer, a round-trip-time (RTT) timer, or a retransmission timer.

According to an embodiment, the method may include associating a DRX configuration from the multiple DRX configurations with an XR session for the XR service based on the at least one DRX configuration parameter.

According to an embodiment, the method may include determining whether there is at least one DRX configuration for the XR service during a DRX active time.

According to an embodiment, the method may include monitoring a physical downlink control channel (PDCCH) search space for the XR service during the DRX active time.

According to an embodiment, the method may include indicating at least one of: a capability to support multiple DRX configurations through at least one of a UE capability information exchange procedure or UE assistance information; whether the UE supports a power saving preference for the XR in a UE capability message; a maximum number of DRX configurations that the UE supports; or a preference of at least one of a common DRX configuration for a legacy unicast and the XR service, a separate DRX configurations for the legacy unicast and the XR service, a common DRX configuration or a per service DRX configuration, or a preferred RTT timer value and a preferred retransmission timer value for XR services in a UE assistance information.

According to an embodiment, the method may include identifying whether at least two DRX configurations are applied for one or more XR service reception.

According to an embodiment, the method may include switching among the at least two DRX configurations from multiple DRX configurations.

According to an embodiment, the method may include receiving an indication of a suitable DRX configuration among the at least two DRX configurations for the XR reception using at least one of a DCI, a WUS, a WUR, or a MAC CE.

According to an embodiment, wherein the indicated DRX configuration may be applicable for a predefined time.

According to an embodiment, the method may include receiving a MAC CellGroupConfig message, wherein the MAC CellGroupConfig message configures a medium access control (MAC) parameter for a cell group including at least one of a setup of drx-Config, a setup of drx-ConfigSecondaryGroup, a release of drx-Config, or a release of drx-ConfigSecondaryGroup for at least one of a legacy unicast or a XR service reception.

According to an embodiment, wherein a DRX configuration may differ in at least one parameter including at least one of a drx-onDurationTimer, a drx-inactivityTimer, a drx-HARQ-RTT-TimerUL, a drx-HARQ-RTT-TimerDL, a drx-RetransmissionTimerUL, a drx-RetransmissionTimerDL, a drx-SlotOffsetXR, a drx-SlotOffsetXR-static, a drx-Shortcycle, a drx-ShortcycleTimer, a drx-LongCycle, a drx-StartOffsetXR, or a drx-StartOffsetXR-static.

According to an embodiment, wherein a HARQ process utilized for the XR service may be a common and shared process with a legacy unicast or a non-XR service.

According to an embodiment, a method performed by a network apparatus in a communication system may be provided.

According to an embodiment, the method may include transmitting, to a user equipment (UE), a radio bearer configuration including an identifier field as an isXR bearer field to identify a radio bearer pertaining to an extended reality (XR) service.

According to an embodiment, the method may include managing the XR service in the wireless network based on the radio bearer configuration including the isXR bearer field.

According to an embodiment, the method may include performing at least one of: transmitting, to the UE, a configurable value or a dynamic value for at least one of a drx-StartOffsetXR or a drx-slotOffsetXR in at least one of downlink control information (DCI), a wakeup signal (WUS), DCI with cyclic redundancy code (CRC) scrambled by power saving-radio network temporary identifier (PS-RNTI) (DCP), a wakeup radio (WUR), a medium access control control-element (MAC CE), or a radio resource control (RRC) signalling for the XR service.

According to an embodiment, the method may include transmitting, to the UE, a RRC re-configuration message including a set of configured values for at least one of a drx-StartOffsetXR or a drx-slotOffsetXR for the XR service.

According to an embodiment, the method may include configuring the UE with at least one DRX configuration parameter from multiple DRX configurations.

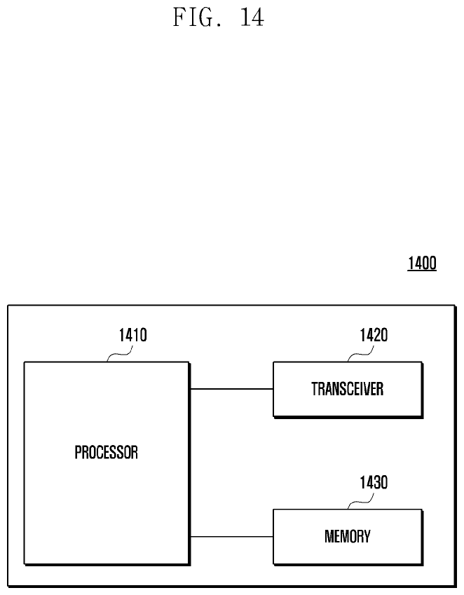

FIG. 14 illustrates an electronic device according to embodiments of the present disclosure.

Referring to the FIG. 14, the electronic device 1400 may include a processor 1410, a transceiver 1420 and a memory 1430. However, all of the illustrated components are not essential. The electronic device 1400 may be implemented by more or less components than those illustrated in FIG. 14. In addition, the processor 1410 and the transceiver 1420 and the memory 1430 may be implemented as a single chip according to another embodiment.

The electronic device 1400 may correspond to the UE described above.

The aforementioned components will now be described in detail.

The processor 1410 may include one or more processors or other processing devices that control the provided function, process, and/or method. Operation of the electronic device 1400 may be implemented by the processor 1410.

The transceiver 1420 may include a RF transmitter for up-converting and amplifying a transmitted signal, and a RF receiver for down-converting a frequency of a received signal. However, according to another embodiment, the transceiver 1420 may be implemented by more or less components than those illustrated in components.

The transceiver 1420 may be connected to the processor 1410 and transmit and/or receive a signal. The signal may include control information and data. In addition, the transceiver 1420 may receive the signal through a wireless channel and output the signal to the processor 1410. The transceiver 1420 may transmit a signal output from the processor 1410 through the wireless channel.

The memory 1430 may store the control information or the data included in a signal obtained by the electronic device 1400. The memory 1430 may be connected to the processor 1410 and store at least one instruction or a protocol or a parameter for the provided function, process, and/or method. The memory 1430 may include read-only memory (ROM) and/or random access memory (RAM) and/or hard disk and/or CD-ROM and/or DVD and/or other storage devices.

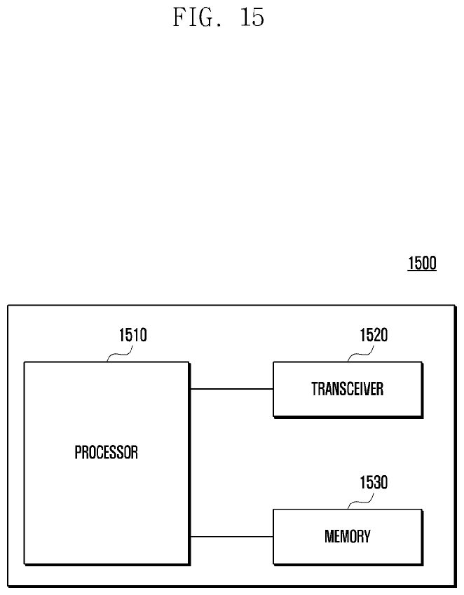

FIG. 15 illustrates a network apparatus according to embodiments of the present disclosure.

Referring to the FIG. 15, the network apparatus 1500 may include a processor 1510, a transceiver 1520 and a memory 1530. However, all of the illustrated components are not essential. The network apparatus 1500 may be implemented by more or less components than those illustrated in FIG. 15. In addition, the processor 1510 and the transceiver 1520 and the memory 1530 may be implemented as a single chip according to another embodiment.

The aforementioned components will now be described in detail.

The processor 1510 may include one or more processors or other processing devices that control the provided function, process, and/or method. Operation of the network apparatus 1500 may be implemented by the processor 1510.

The transceiver 1520 may include a RF transmitter for up-converting and amplifying a transmitted signal, and a RF receiver for down-converting a frequency of a received signal. However, according to another embodiment, the transceiver 1520 may be implemented by more or less components than those illustrated in components.

The transceiver 1520 may be connected to the processor 1510 and transmit and/or receive a signal. The signal may include control information and data. In addition, the transceiver 1520 may receive the signal through a wireless channel and output the signal to the processor 1510. The transceiver 1520 may transmit a signal output from the processor 1510 through the wireless channel.

The memory 1530 may store the control information or the data included in a signal obtained by the network apparatus 1500. The memory 1530 may be connected to the processor 1510 and store at least one instruction or a protocol or a parameter for the provided function, process, and/or method. The memory 1530 may include read-only memory (ROM) and/or random access memory (RAM) and/or hard disk and/or CD-ROM and/or DVD and/or other storage devices.

The various actions, acts, blocks, steps, or the like in the flow charts (400-1300) may be performed in the order presented, in a different order or simultaneously. Further, in some embodiments, some of the actions, acts, blocks, steps, or the like may be omitted, added, modified, skipped, or the like without departing from the scope of the present disclosure.

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment herein, those skilled in the art will recognize that the embodiments herein can be practiced with modification within the spirit and scope of the embodiments as described herein.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a communication system, the method comprising:
receiving a radio bearer configuration associated with a radio bearer;
determining whether the radio bearer configuration includes an identifier field associated with extended reality (XR); and
identifying the radio bearer being associated with an XR service based on determining that the radio bearer configuration includes the identifier field.

2. The method of claim 1, further comprising: performing an XR service communication associated with the XR service based on the identification,
wherein the XR service communication is scheduled based on a physical downlink control channel (PDCCH) addressed to one of a first radio network temporary identifier (RNTI) or a second RNTI,
wherein the first RNTI is one of a cell-RNTI (C-RNTI) or a configured scheduling-RNTI (CS-RNTI), and
wherein the second RNTI is one of an XR-RNTI or an XR-CS-RNTI.

3. The method of claim 2, wherein in case that the PDCCH is addressed to the first RNTI, the XR service communication is multiplexed with communication associated with non-XR service.

4. The method of claim 1, wherein a hybrid automatic repeat and request (HARQ) process utilized for the XR service is a shared process with a HARQ process utilized for non-XR service.

5. The method of claim 1, further comprising:
receiving configuration information associated with multiple discontinuous reception (DRX) configurations; and
monitoring a PDCCH search space for the XR service based on a first DRX configuration among the multiple DRX configurations.

6. The method of claim 5, wherein the multiple DRX configurations differ from each other in at least one DRX parameter including at least one of a drx-onDurationTimer, a drx-inactivityTimer, a drx-HARQ-RTT-TimerUL, a drx-HARQ-RTT-TimerDL, a drx-RetransmissionTimerUL, a drx-RetransmissionTimerDL, a drx-SlotOffsetXR, a drx-SlotOffsetXR-static, a drx-Shortcycle, a drx-ShortcycleTimer, a drx-LongCycle, a drx-StartOffsetXR, or a drx-StartOffsetXR-static.

7. The method of claim 5, further comprising:
switching to a second DRX configuration among the multiple DRX configurations, wherein the second DRX configuration is different from the first DRX configuration; and
monitoring a PDCCH search space for the XR service based on the second DRX configuration.

8. A user equipment (UE) in a communication system, the UE comprising:
a transceiver; and
a processor coupled with the transceiver and configured to:
receive a radio bearer configuration associated with a radio bearer;
determine whether the radio bearer configuration includes an identifier field associated with extended reality (XR); and
identify the radio bearer being associated with an XR service based on determining that the radio bearer configuration includes the identifier field.

9. The UE of claim 8, wherein the processor is further configured to perform an XR service communication associated with the XR service based on the identification,
wherein the XR service communication is scheduled based on a physical downlink control channel (PDCCH) addressed to one of a first radio network temporary identifier (RNTI) or a second RNTI,
wherein the first RNTI is one of a cell-RNTI (C-RNTI) or a configured scheduling-RNTI (CS-RNTI), and
wherein the second RNTI is one of an XR-RNTI or an XR-CS-RNTI.

10. The UE of claim 9, wherein in case that the PDCCH is addressed to the first RNTI, the XR service communication is multiplexed with communication associated with non-XR service.

11. The UE of claim 8, wherein a hybrid automatic repeat and request (HARQ) process utilized for the XR service is a shared process with a HARQ process utilized for non-XR service.

12. The UE of claim 8, wherein the processor is further configured to:
receive configuration information associated with multiple discontinuous reception (DRX) configurations; and
monitor a PDCCH search space for the XR service based on a first DRX configuration among the multiple DRX configurations.

13. The UE of claim 12, wherein the multiple DRX configurations differ from each other in at least one parameter including at least one of a drx-onDurationTimer, a drx-inactivityTimer, a drx-HARQ-RTT-TimerUL, a drx-HARQ-RTT-TimerDL, a drx-RetransmissionTimerUL, a drx-RetransmissionTimerDL, a drx-SlotOffsetXR, a drx-SlotOffsetXR-static, a drx-Shortcycle, a drx-ShortcycleTimer, a drx-LongCycle, a drx-StartOffsetXR, or a drx-StartOffsetXR-static.

14. The UE of claim 12, wherein the processor is further configured to:
switch to a second DRX configuration among the multiple DRX configurations, wherein the second DRX configuration is different from the first DRX configuration; and
monitor a PDCCH search space for the XR service based on the second DRX configuration.

15. A method performed by a network apparatus in a communication system, the method comprising:
identifying whether a radio bearer is associated with an extended reality (XR) service;
transmitting a radio bearer configuration associated with the radio bearer, wherein the radio bearer configuration includes an identifier field associated with XR based on identifying that the radio bearer is associated with the XR service; and
performing communication associated with the XR service.

16. The method of claim 15, wherein performing the communication comprises:
transmitting a physical downlink control channel (PDCCH) scheduling an XR service communication associated with the XR service; and
performing the XR service communication,
wherein the PDCCH is addressed to one of a first radio network temporary identifier (RNTI) or a second RNTI,
wherein the first RNTI is one of a cell-RNTI (C-RNTI) or a configured scheduling-RNTI (CS-RNTI), and
wherein the second RNTI is one of an XR-RNTI or an XR-CS-RNTI.

17. The method of claim 16, wherein in case that the PDCCH is addressed to the first RNTI, the XR service communication is multiplexed with communication associated with non-XR service.

18. A network apparatus in a communication system, the network apparatus comprising:
a transceiver; and
a processor coupled with the transceiver and configured to:
identify whether a radio bearer is associated with an extended reality (XR) service;
transmit a radio bearer configuration associated with the radio bearer, wherein the radio bearer configuration includes an identifier field associated with XR based on identifying that the radio bearer is associated with the XR service; and
perform communication associated with the XR service.

19. The network apparatus of claim 18, wherein the processor is further configured to:
transmit a physical downlink control channel (PDCCH) scheduling an XR service communication associated with the XR service; and
perform the XR service communication,
wherein the PDCCH is addressed to one of a first radio network temporary identifier (RNTI) or a second RNTI,
wherein the first RNTI is one of a cell-RNTI (C-RNTI) or a configured scheduling-RNTI (CS-RNTI), and
wherein the second RNTI is one of an XR-RNTI or an XR-CS-RNTI.

20. The network apparatus of claim 19, wherein in case that the PDCCH is addressed to the first RNTI, the XR service communication is multiplexed with communication associated with non-XR service.
